(19) United States
(12) Patent Application Publication
(10) Pub. No.: US 2012/0031287 A1
(43) Pub. Date: Feb. 9, 2012

(54) Process of creating a detailed master picture in a hinged stencil book

(76) Inventors: Robert Louis Ingraselino, Coram, NY (US); Joseph Vito Ingraselino, Oakdale, NY (US)

(21) Appl. No.: 13/066,829

(22) Filed: Apr. 26, 2011

Related U.S. Application Data
(60) Provisional application No. 61/400,875, filed on Aug. 5, 2010.

(51) Int. Cl. B05C 17/06

(52) U.S. Cl. 101/127

(57) ABSTRACT

A coloring book for method is provided creating a detailed master picture in a hinged stencil book with the steps of: folding the master page in between each stencil then coloring each stencil page color onto the master page. When all colors or pages are colored the master page will have a completed detailed picture.

### CROSS REFERENCE TO RELATED APPLICATIONS

This application is based on provisional application Ser. No. 61/400,875, filed on Aug. 5, 2010.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of coloring books and stencil kits and more specifically to a book method of creating a detailed picture by separating each individual color from a picture into its own hinged stencil page having an opposing hinged page securing a master picture page that folds in between each stencil page. When all colors or pages are colored the master page will have a completed picture.

In the prior art there are various types of coloring toys and stencil kits that have been proposed. Typical of these is U.S. Pat. No. 5,141,438 issued to Donald Spector on May 1, 1991.

Another patent was issued to Kea L. Bardeen on Feb. 23, 1998 as U.S. Pat. No. 6,055,738. Yet another U.S. Pat. No. 5,213,504 was issued to James S. W. Lee on May 31, 1991 and still yet another was issued on Mar. 23, 1993 to Angelo J. Casale U.S. Pat. No. 5,195,893

U.S. Pat. No. 5,141,438

Inventor—Donald Spector

Issued—May 1, 1991

An art craft kit which makes it possible for a child to reproduce a painting, a map, or other multi-colored artwork printed on a master sheet having a pressure sensitive adhesive backing, the master sheet being adhered to the face of a blank canvas or other copy sheet. The printed artwork is dissected into stencil segments, the periphery of each segment being defined by contoured line defining a selected segment, thereby cutting this line and separating the segment which is then removed from the master sheet to expose a corresponding blank segment on the copy sheet. Using the removed stencil segment as a guide, the child colors in the blank segment of the copy sheet to match as best he can, the portion of the artwork appearing on the removed segment. This operation is subsequently repeated until all stencil segments on the master sheet are removed and the artwork is reproduced on the copy sheet.

U.S. Pat. No. 6,055,738

Inventor—Kea L. Bardeen

Issued—Feb. 23, 1998

This invention is directed to a stencil for use in transferring an image to a substrate where the image is formed by an ensemble of individual features for a predetermined image. The stencil comprises a sheet of flexible material and a plurality of holes formed through the sheet. The holes are organized in a hole sets such that the holes in each such hole set outline a respective individual feature. The hole sets together define the predetermined image to be transferred. This invention also includes a kit for use in transferring an image to an outer surface of a vegetable.

U.S. Pat. No. 5,213,504

Inventor—James S. W. Lee

Issued—May 31, 1991

A liquid non-poisonous, non-metallic, edible, water soluble coloring fluid fills a felt-tipped marker. A plastic box houses the marker or a plurality of the markers. A surface on the box receives the marks from the felt-tipped marker. In one embodiment, the box is in the form of a toy vehicle. In other embodiments, there may be a plurality of stencils which can be arranged in a scene or a scroll which may be rolled to display a selected scene. Then a tracing of the scene may be made on an overlaying sheet of transparent plastic. An eraser in the form of a sponge with a plastic handle may be made wet to wash away the marks.

U.S. Pat. No. 5,195,893

Inventor—Angelo J. Casale

Issued—Jan. 9, 1991

A shape retaining stencil for three dimensional image placement. This is for the placement of images on non-flat objects and surfaces. There is a material that has a plurality of holes defying the pattern, the material is fit against a non-flat object, marks are made through the holes of the sheet, which the dots are connected to provide the pattern on the surface.

While these inventions may be suitable for the purposes for which they were designed, they would not be suitable for the purposes of the present invention, as hereinafter described.

### BRIEF SUMMARY OF THE INVENTION

The primary object of the invention is To provide a stencil paged coloring apparatus/book with hinged pages that creates a detailed master picture when all of the stencil pages are colored onto the master page.

Another object of the invention is To provide hinged stencil pages that are each a different color of the master picture.

Another object of the invention is To provide a opposing hinged master page that folds in between each stencil page.

Another object of the invention is to provide slots in the opposing hinged master page to secure the page that the picture is created on.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process of creating a detailed master picture in a hinged stencil book comprising the steps of: multiple hinged stencil pages that together create a master picture, each stencil page represents an individual color of the master picture, an opposing hinged page that is able to fold in between each stencil page, and slots in the opposing hinged page to insert and secure the blank master page.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a view of the book in the open position showing the stencil pages in the middle of the book with the cover page on the left and the blank insert master page on the right with out the master page inserted yet.

FIG. 2 is a view of the book with the masterpage inserted and the first color stencil folded overlapping on top of the master picture page ready to be colored.

FIG. 3 is a view of the first color stencil page turned to the left and the next color stencil page folded overlapping the master picture page ready to be colored.

FIG. 4 is a view of the stencil pages turned to the left with the finished picture on the master page in its completed state.

### LIST OF REFERENCE NUMERALS

With regard to the reference numerals used, the following numbering is used throughout the drawings.
10—Stencil pages each representing a different color of the master picture
12—Stencil Binding/fold/hinge that allows the stencil pages to turn in the book
14—Opposing binding/fold/hinge that allows the master picture page to turn in between each stencil page.
16—Insert slots that secures the master page and holds it in place.
18—The master picture page that the picture is created onto.
20—The finished product of all the color stencils colored onto the master page creating the completed detailed picture.
22—The front cover page.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

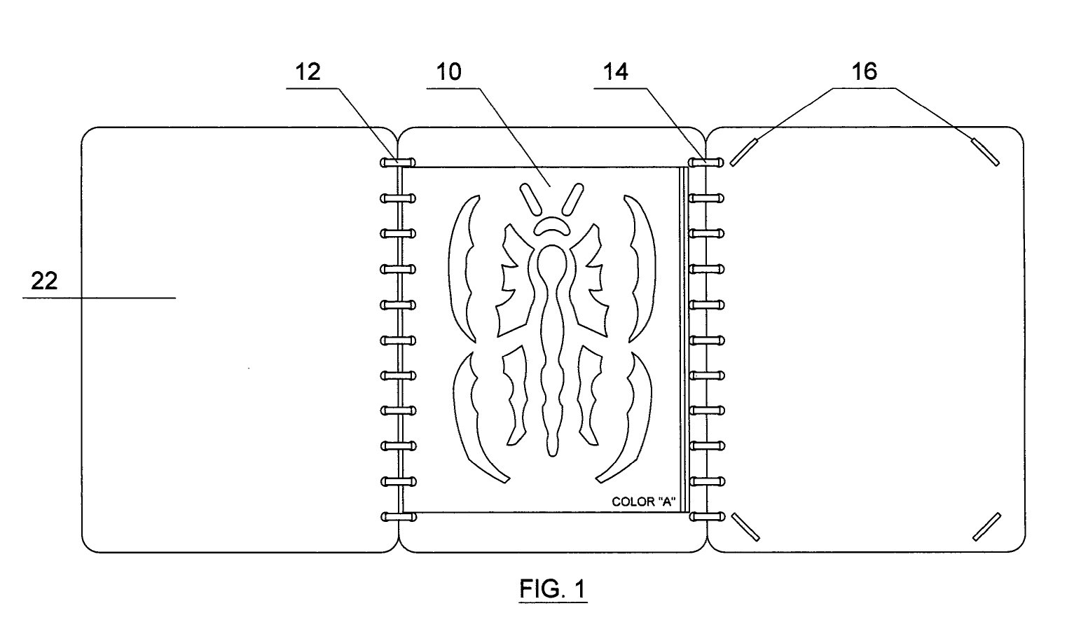

Turning to FIG. 1, shown therein is a view of the present invention in the open position showing the stencil pages -10- in the middle of the book with the cover page -22- on the left and the stencil fold/bind/hinge -12- shown towards the left and the master page bind/fold/hinge -14- towards the right side, also the master page insert slots -16- on the right without the master page inserted yet.

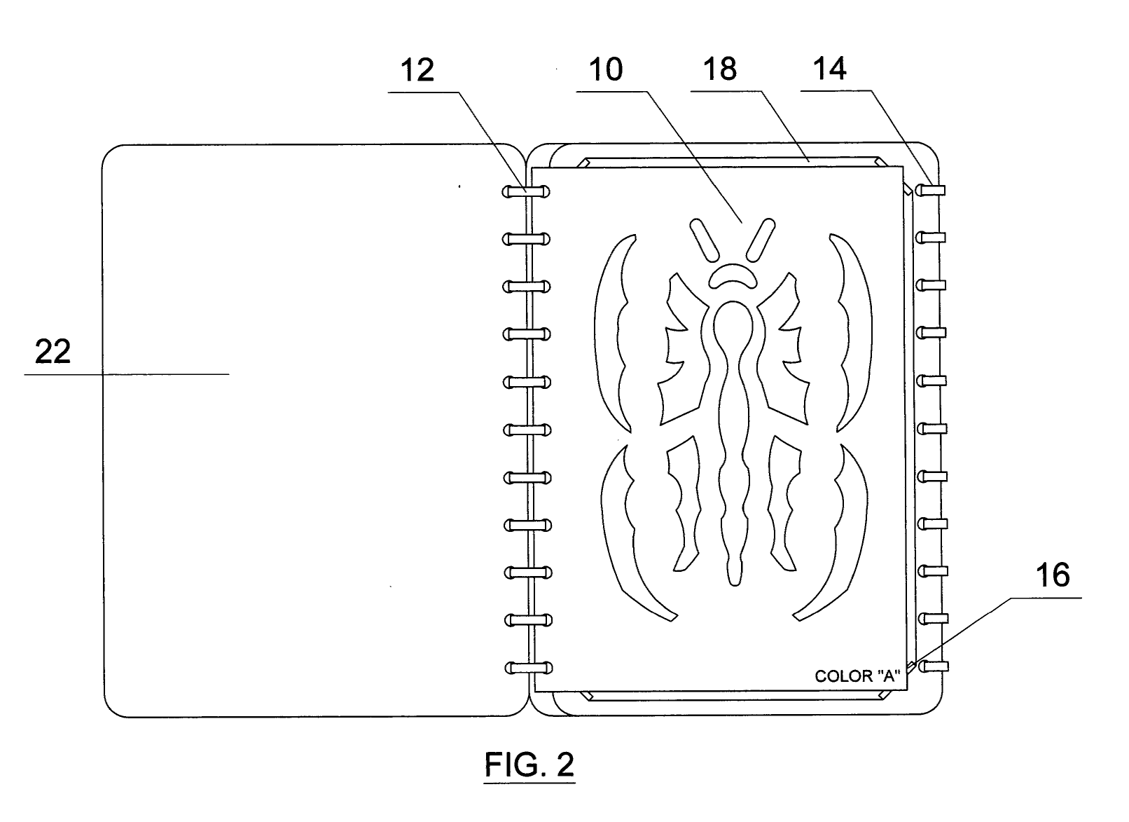

Turning to FIG. 2, shown therein is a view of the book with the masterpage -18- inserted into the stencil slots -16- and the first color stencil page -10- folded overlapping on top of the master page -18- ready to be colored also showing the stencil page bind/fold/hinge -12- and the master page bind/fold/hinge -14- with the cover page -22- on the left.

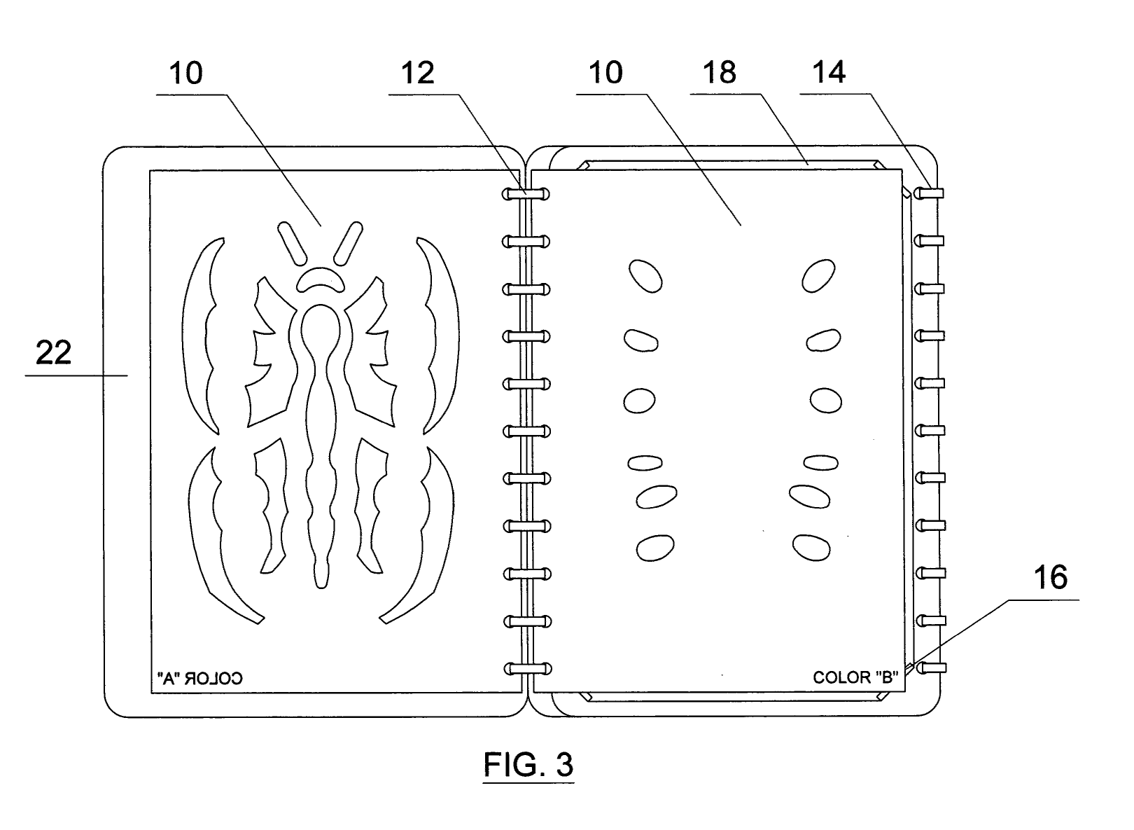

Turning to FIG. 3, shown therein is a view of the book with the first color stencil page -10- turned to the left and the next color stencil page -10- folded overlapping the master picture page -18- ready to be colored, also shown is the stencil page bind/fold/hinge -12-, the master page bind/fold/hinge -14-, the master page is inserted into the insert slots -16- and the cover page -22- is on the left.

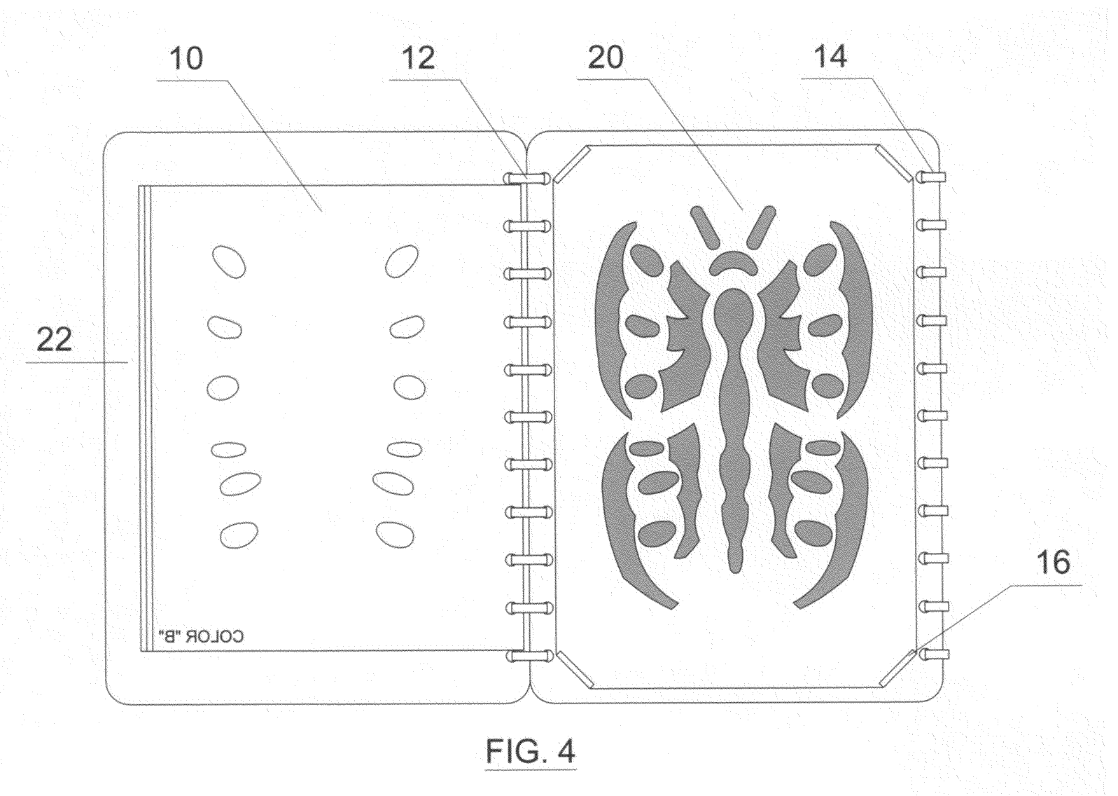

Turning to FIG. 4, shown therein is a view of the present invention with the stencil pages -10- turned to the left with the finished picture -20- in its completed state, also shown is the stencil page bind/fold/hinge -12- and the master page bind/fold/hinge -14-, the finished picture -20- is inserted into the slots -16- and the cover page -22- is on the left.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A book format with the process of creating a detailed multicolor master picture in a hinged stencil book comprising:
a) a cover page for said book
b) a plurality of stencil pages
c) a bind/fold/hinge holding the stencil pages into the book
d) a back master page that holds the master picture page
e) a bind/fold/hinge holding the back master page into the book hinging/folding/binding on the opposing side from the stencil page hinge/fold/bind.
f) a plurality of slots in the back master page to hold in and secure the picture page.

2. a process of creating a detailed picture providing a blank master picture page that is inserted into slots of a bound/hinged/fold master back page securing page to be colored,
folding the first colored stencil overlapping on top of the master picture page, then applying a coloring material through the stencil onto the master picture page forming that color portion of the picture on the master picture page, then
folding the next color stencil page overlapping on top of the master picture page, then applying a coloring material through the stencil onto the master picture page forming the next color portion of the picture on the master picture page, repeating this process for every color stencil page in the book, when all of the color stencil pages are completed the master picture will be complete, the user may now remove the master picture page from the slots.
